(19) United States
(12) Patent Application Publication
(10) Pub. No.: US 2002/0120838 A1
(43) Pub. Date: Aug. 29, 2002

(54) Data encryption using stateless confusion generators

(76) Inventor: Barbir Abdulkader, Nepean (CA)

Correspondence Address: Gowling Lafleur Henderson LLP, Suite 2600, 160 Elgin Street, Otawa, ON, K1P 1C3, CA

(21) Appl. No.: 10/014,474

(22) Filed: Dec. 14, 2001

(30) Foreign Application Priority Data
Dec. 29, 2000 (CA) 2,330,166

(51) Int. Cl. H04L 9/00; H04K 1/06

(52) U.S. Cl. 713/153; 380/37

(57) ABSTRACT

This invention provides for the encoding of synchronization information in the transmitted streamed data so that the receiver and transmitter may synchronize their internal cipher states. It uses a random number generator at the transmitter subsystem as well as one-way cryptographic hash functions, and streaming cipher algorithms at both the transmitter subsystem and the receiver subsystem. The output of the random number generator at the transmitter is included in the transmitted data packet, and data in the packet is encrypted using a key derived from this same output value. Since this derivation is carried out using a number of encryption steps, such as a one-way hash function and a streaming cipher algorithm, to produce a key that is then used to encrypt the data before it is transmitted, the value of this key is of little use in decrypting the message. Thus, each packet now contains the information needed to generate the correct unique decryption key by the intended receiver and every packet effectively resynchronizes the encryption functions.

### FIELD OF INVENTION

This invention relates to the field of data encryption and security.

### BACKGROUND OF THE INVENTION

Stream ciphers provide a fast mechanism for encrypting data. They are in general secure and fast to implement in software. A stream cipher is a type of symmetric encryption algorithm. Stream ciphers can be designed to be exceptionally fast, much faster than any block cipher.

In an inter-networking environment, stream ciphers can be implemented in software to achieve high encryption rate without the need for specialized hardware. One limitation of stream ciphers is that they generate a continuous stream of encryption bits. Hence, for accurate decryption of the ciphered stream, the receiver and the transmitter must stay synchronized. In order to keep the receiver and transmitter synchronized, a reliable data transmission method such as Transmission Control Protocol/Internet Protocol (TCP/IP) must be used. In the event that data is lost on the transmission medium, the two stream cipher based engines at the receiver and transmitter must be restarted. An intruder who manages to attack a system and who causes frequent resets could have access to valuable information about the keys that are used in the encryption process. This results because every time the system is reset, the stream of encryption bits is repeated. The security of the overall system is compromised in cases where the initial text of messages contains expected or guessable information such as email headers. Potential intruders with this knowledge and a frequently restarted random number generator are more likely to be successful.

An example of a stream cipher algorithm that is widely used in the industry to provide adequate security of data for wide range of applications such as e-commerce is RC4 developed by RSA Laboratories of Bedford, Mass. The RC4 algorithm utilizes keys to generate a stream of ‘confusion’ bits that are combined with the original data to hide its nature from an unauthorized observer. It is a variable key-size stream cipher with byte-oriented operations. The algorithm is based on the use of a random permutation.

In a typical system, the implementation of the RC4 algorithm consists of two steps. In the first step, an encryption key is used to setup and randomize an array of elements. This array of elements is used as a state machine. In the second step, the state machine generated by the first step is used to generate the stream of cipher bits in order to encrypt and decrypt the transmitted or received data respectively. It is important to note that the encryption key and the first step of the RC4 algorithm are only used at the beginning of the process. In the event of data loss or lack of synchronization, the link must be dropped and the first step restarted.

In order to secure the original data against modification by an intruder, it is a common practice to apply a one-way cryptographic hash function on the original text of the message. In this approach a one-way hash function is applied on the original content. This function results in value that is usually fixed in length. The resultant value is then encrypted using an encryption key. The receiver of the message performs the same operation and compares the results of the one-way cryptographic hash function. If the results are the same, the receiver can conclude that the received message is authentic. In this invention the use of one-way hash function implies the generation of the hash value that is followed by an encryption step.

To solve such problems, techniques that are based on block ciphers are generally used. A block cipher is a type of symmetric-key encryption algorithm that transforms a fixed-length block of plain or unencrypted text data into a block of cipher or encrypted text data of the same length. This transformation takes place under the action of a user-provided secret key. Decryption is performed by applying the reverse transformation to the cipher text block using the same secret key.

Block ciphers are less sensitive to the synchronization problem that is caused by the loss of data on the transmission medium. One drawback of using block ciphers is related to their requirement for considerable processing power. To speed up the performance of real time systems, hardware assisted implementations may be needed.

In systems that are deployed in the field with limited processing power, it could be beneficial if techniques that are based on stream ciphers could be used to provide some measure of security for transmitting the data on network links. The same analysis apply to those systems that use protocols such as the User Datagram Protocol (UDP) that does not guarantee data delivery.

What is needed is some mechanism to combine the ease of implementation and speed of operation of stream ciphers with the tolerance to desynchronization and data loss of block ciphers.

### SUMMARY OF THE INVENTION

In this invention a method is provided that allows the encoding of synchronization information in the transmitted data that enable systems that use stream ciphers to self-synchronize their states. Hence, the invention provides a method and mechanism that allows the use of stream ciphers in systems that do not guarantee the delivery of data such as UDP and other non-reliable links. The invention provides a method that allows the encoding of synchronization information in the transmitted data that enable the receiver and transmitter to self synchronize their internal cipher states.

According to the invention, there is provided a packet-based encryption system comprising: a transmitting device to encrypt data and to insert a pseudo-random key in a transmitted packet; and a receiving device to receive and to decrypt said data in said transmitted.

Other advantages, objects and features of the present invention will be readily apparent to those skilled in the art from a review of the following detailed description of preferred embodiments in conjunction with the accompanying drawings and claims

### BRIEF DESCRIPTION OF THE DRAWINGS

The embodiments of the invention will now be described with reference to the accompanying drawings, in which:

FIG. 1 is a basic block diagram of the system showing the major subsystems and components; and

FIG. 2 depicts the major steps in carrying out the invention using a flow chart format.

### DETAILED DESCRIPTION OF THE INVENTION

The invention involves the use of a random number generator at the transmitter subsystem and a one-way cryptographic hash function, and streaming cipher algorithm at both the transmitter subsystem and the receiver subsystem. The approach uses the one-way hashing function as a vehicle to securely transmit the self-synchronizing data. Common elements are connected in a similar fashion at both the transmitter and receiver subsystems. An external means is required to ensure that various security keys, such as seeds or keys for the one-way hash functions and the streaming cipher algorithms, are synchronized.

At the transmitter the method provides for the inclusion of the output of the random number generator at the transmitter as a field in the transmitted data packet. The actual data in the packet is encrypted using a key derived from this same output value. This derivation is carried out using the one-way cryptographic hash function and the streaming cipher algorithm to produce a key that is used to encrypt the data using a further streaming cipher algorithm before it is transmitted.

At the receiver the data packet is parsed to provide the encrypted data and the result of the random number generator provided at the transmitter. This value is then passed through an identical chain of components including the one-way hash function and streaming cipher algorithm to provide the decryption key which is then applied to the encrypted data.

Since each packet now contains a field with a random value, and this value can only be effectively used to generate the correct unique decryption key by the intended receiver, there is no need to restart the streaming cipher process when data is lost or corrupted. Each and every packet effectively resynchronizes the encryption functions.

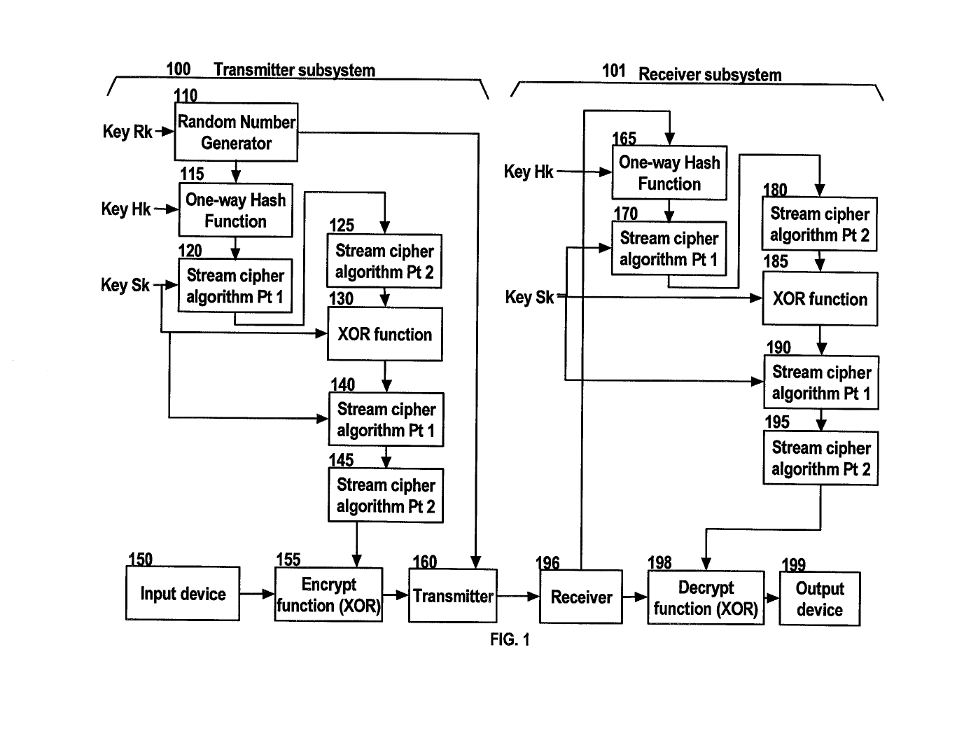

Turning first to FIG. 1 we describe the system and the progress of both data and the various encryption and decryption functions. A transmitter subsystem 100 comprises two major sections, relating to the data path and the creation of the encryption key based on a random number generator 110. Data is assembled as a packet in the input device 150 and is encrypted using the encryption function 155 before being passed to the transmitter 160. At the start of the procedure for generating a new packet, a random number generator 110, seeded with a secret key Rk passes its result to a one-way hash cryptographic function 115, itself seeded with a secret key Hk. The output of this function 115 is one of the inputs to a stream cipher algorithm 120, 125, the other being yet another secret key Sk. Each time the stream cipher algorithm is started a new array is generated in the first part of the algorithm 120 for use as the states in the second part of the algorithm 125. The second part is used to encrypt output of the one-way hash function 120 using the key Sk for use as the seed or key to another stream cipher algorithm 140, 145. The second part of this algorithm 145 is used multiple times by the encrypt function 155 until all of the data is passed to the transmitter 160. Once the data is all encrypted, the value of the output of the random number generator 110 is included in the packet which is then sent.

On completion of the packet, a new packet assembly process begins, with a new random number being generated and the overall process repeats itself until all data has been transmitted.

The receiver subsystem behaves similarly, with the exception that the initial seed or key used to start the process of decryption is extracted from the incoming packet at the receiver 196. This key is passed through a one-way cryptographic hash function 165 having the same characteristics as that in the transmitter 115, and using the same secret key Hk. As with the transmitter subsystem the output of the one-way hash function 165 is passed through a stream cipher algorithm 170, 180, using the same secret key value Sk as was used in the transmitter. This secret key is then encrypted by a further stream cipher algorithm 190, 195 before being used in a decrypting function 198. The data from the receiver 196 is then decrypted 198 with the second part of the stream cipher algorithm 195 being used multiple times until all of the data has been decrypted.

As each new packet is received, the process repeats, with the various functions using the new value of the transmitted random number as required, until all of the data has been received.

The approach requires the use of a random number generator. The seeds of the random number generator must be available for the receiver and the transmitter. The method of exchanging the keys are beyond the scope of this invention.

An example of a one-way cryptographic hashing function is the message digest based on MD5. It is assumed that the system is capable of performing an MD5 computation and that the receiver and the transmitter have access to the same keys that are used in performing the MD5 operation. The method of exchanging the keys is beyond the scope of this invention. Without any loss of generality, other one-way hashing functions could also be used.

Although the RC4 algorithm has been used to generate the ‘confusion’ bits at the receiver and the transmitter using a key that is known to both parties, this does not restrict the applicability of this invention to other classes or types of stream cipher. The method of exchanging the keys is beyond the scope of this invention.

In another embodiment of the invention, the first of the stream cipher algorithms in both the transmitter 120, 125 and the receiver 180, 185 is replaced by a second one-way hash function.

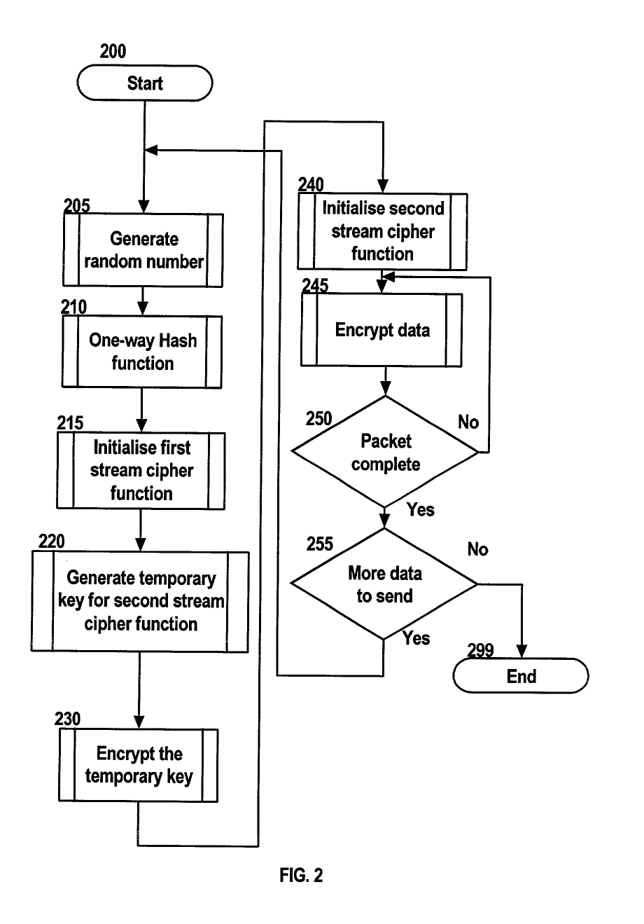

Referring now to FIG. 2, the transmitter performs the following steps before encrypting each packet:

Following the start 200, generate a random number 205 using the random number generator. The size in bits of the random number is a function of the security requirements of the system and in general should be larger that 40 bits.

Perform a one-way cryptographic hash function 210 (e.g., MD5) on the value generated by the Random number generator.

Use the value that is generated by one-way cryptographic hash function as a key to seed the first step of the stream cipher function RC4 initialization process 215.

Generate cipher bits 220 from the second step of the RC4 algorithm that is equal to the size of the encryption key that is used for the stream cipher. These bits are treated as a temporary key.

Encrypt the key of the stream cipher algorithm 230 by performing the mathematical XOR operation on the bits of the temporary key as generated from the previous step. This operation results in the key that is used to encrypt the data before is sent on the transmission medium.

Use the key that was generated in step 5 to initialize 240, and generate the encryption data 245 using the second RC4 stream cipher. As each part of the packet is encrypted a check is performed 250 to see if the packet has been completed. If not the encryption process 245 is repeated. Once the packet has been completely encrypted, the process checks to see if there are more data to be packetized 255. If there are, the process restarts by generating a new random number 205, otherwise the process ends 299.

The transmitter must send the value that was generated by the random number generator as part of the data. This value can be easily included in the data as part of the transmitted frame.

Upon receiving the data packets which contain the encrypted data as well as the random number, the receiver performs the exact same steps as the transmitter in order to decrypt the data using the random number from the data packet rather than generating another one.

The above describes a method that self synchronizes the internal states of stream ciphers on a packet-by-packet basis. The method provides added means to enhance the security of stream ciphers. Systems that use the proposed method are less susceptible to attacks that try to infer the states of the stream cipher by causing loss of synchronization of data on the links. In this invention, frequent restarting of the stream cipher does not lead to replicated cipher bits, thus reducing the susceptibility to security attacks which might rely on such restarts.

The invention can exploit any class of stream ciphers that use an encryption key to randomize the cipher. The invention is only appropriate for symmetric stream ciphers.

In a further embodiment of the invention the random number generator multiple values to generate an array of temporary keys that are used together with the original stream cipher encryption key to generate encryption keys for each of several separate data packets. Furthermore, it is possible to use the results of the one-way cryptographic hash function to be directly XOR-ed with the cipher key to encrypt or decrypt the data.

Numerous modifications, variations and adaptations may be made to the particular embodiments of the invention described above without departing from the scope of the invention, which is defined in the claims.

What is claimed is:

1. A packet-based encryption system comprising:
a transmitting device to encrypt data and to insert a pseudo-random key in a transmitted packet; and
a receiving device to receive and to decrypt said data in said transmitted packet using said pseudo-random key.

2. The system of claim 1 wherein said transmitting device further comprises:
means to generate a random number;
a first one-way cryptographic hash function means to generate a hashed number from said random number;
a first streaming cipher algorithm using a seed to encrypt said hashed number;
encryption means to encrypt said data using results of said first streaming cipher algorithm; and
means to insert said random number in a specified field of said transmitted packet.

3. The system of claim 2 wherein said receiving device further comprises:
means to remove said random number from said specified field of said transmitted packet;
a second one-way cryptographic hash function means to generate a second hashed number from said random number;
a second streaming cipher algorithm using a seed to encrypt said second hashed number; and
decryption means to decrypt said data using results of said second streaming cipher algorithm.

4. The system of claim 3 wherein said first one-way cryptographic hash function and said second one-way cryptographic hash function use the same algorithm and use a same first seed or key.

5. The system of claim 4 wherein said first streaming cipher algorithm and said second streaming cipher algorithm are the same and use a same second seed or key.

6. The system of claim 5 wherein said encryption means and said decryption means use the same third key and algorithm.

7. The system of claim 1 wherein said transmitting device further comprises:
means to generate a random number;
a first one-way cryptographic hash function means to generate a hashed number from said random number;
a third one-way cryptographic hash function using a seed to encrypt said hashed number;
encryption means to encrypt said data using results of said third one-way cryptographic hash function; and
means to insert said random number in a specified field of said transmitted packet.

8. The system of claim 7 wherein said receiving device further comprises:
means to remove said random number from said specified field of said transmitted packet;
a second one-way cryptographic hash function means to generate a second hashed number from said random number;
a fourth one-way cryptographic hash function using a seed to encrypt said second hashed number; and
decryption means to decrypt said data using results of said fourth one-way cryptographic hash function.

9. The system of claim 8 wherein said third one-way cryptographic hash function and said fourth one-way cryptographic hash function are the same and use a same fourth seed or key.

10. A method of encryption of packetized data using a symmetric key-based stream cipher, in which each packet includes self-synchronizing information comprising the steps of:
encrypting data and inserting a pseudo-random key in a transmitted packet with said encrypted data; and
decrypting said data in said transmitted packet with said inserted pseudo-random key.

11. The method of claim 10 further comprising the steps of:
at the transmitting end:
generating a random number;
generating a hashed number from said random number using a first one-way cryptographic hash function;
providing a first streaming cipher algorithm using said hashed number as a seed;
encrypting said data using results of said first streaming cipher algorithm; and
inserting said random number in a specified field of said transmitted packet.
at the receiving end:
removing said random number from said specified field of said transmitted packet;
generating a second hashed number from said random number using a second one-way cryptographic hash function;
providing a second streaming cipher algorithm using said hashed number as a seed; and
decrypting said data using results of said second streaming cipher algorithm using said second hashed number as a seed.

12. The method of claim 10 further comprising the steps of:
at the transmitting end:
generating a random number;
generating a hashed number from said random number using a first one-way cryptographic hash function;
providing a third one-way cryptographic hash function using a seed to encrypt said hashed number;
encrypting said data using results of said first streaming cipher algorithm; and
inserting said random number in a specified field of said transmitted packet.
at the receiving end:
removing said random number from said specified field of said transmitted packet;
generating a second hashed number from said random number using a second one-way cryptographic hash function;
providing a fourth one-way cryptographic hash function using a seed to encrypt said second hashed number; and
decrypting said data using results of said second streaming cipher algorithm using said second hashed number as a seed.
